(19) United States
(12) Patent Application Publication
(10) Pub. No.: US 2013/0314279 A1
(43) Pub. Date: Nov. 28, 2013

(54) ELECTRONIC DEVICE

(71) Applicant: Xacti Corporation, Daito city (JP)

(72) Inventors: Haoming Shen, Moriguchi-shi (JP); Yoshiyuki Otani, Moriguchi-shi (JP)

(21) Appl. No.: 13/937,743

(22) Filed: Jul. 9, 2013

Related U.S. Application Data
(63) Continuation of application No. PCT/JP2012/051292, filed on Jan. 23, 2012.

(30) Foreign Application Priority Data
Jan. 28, 2011 (JP) 2011-016126

(51) Int. Cl. G01S 19/34

(52) U.S. Cl. CPC G01S 19/34
USPC 342/357.74

(57) ABSTRACT

An electronic device that has a host device, includes: a positioning processing portion that positions the host device based on a signal from a satellite; and a positioning control portion that performs a back positioning control operation of intermittently performing the positioning as back positioning in a specific time period including an off-period in which power of the host device is off Here, the positioning control portion compares a time difference between a time when a preceding round of positioning is successfully performed with respect to a starting time of the specific time period and the starting time of the specific time period with a predetermined first reference time, and prevents a start of the back positioning control operation when the time difference is equal to or more than the first reference time.

### BACKGROUND OF THE INVENTION

1. Field of the Invention

The present invention relates to an electronic device including a host device such as a digital camera.

2. Description of Related Art

A GPS receiver may be attached to a host device such as a digital camera. The GPS receiver receives signals from three or more satellites forming the global positioning system, obtains ephemeris data from the reception signals and thereby can position the host device.

As the method of the positioning, there are a cold start in which about 36 or more seconds are needed to complete the positioning and a hot start in which ephemeris data obtained in the past is used to be able to complete the positioning in about 5 seconds. By the utilization of the hot start, it is possible to increase the speed of positioning. However, there is a time limit in the performance of the hot start, and it is possible to perform the hot start only within a specified time (about 2 hours) since the preceding round of acquisition of ephemeris data. After the specified time has elapsed since the preceding round of acquisition of ephemeris data, only the cold start can be performed. Hence, in an electronic device in which, as the power of a host device is turned off, the power of a GPS receiver is turned off, when the power of the host device is kept off for the specified time or more only the cold start can be performed at the time of the subsequent startup of the host device, with the result that a user needs to wait for a relatively long period of time until the result of positioning is obtained.

In view of the foregoing, there is proposed a method of updating ephemeris data held in a GPS receiver by periodically repeating a positioning operation by the GPS receiver while the power of the host device is off. Positioning while the power of the host device is off is also called back positioning. In this method, when the remaining battery capacity of the electronic device reaches a predetermined value, the back positioning is stopped.

The back positioning is periodically performed, and thus even if a time period during which the power of the host device is off is longer than the specified time, when the power of the host device is subsequently turned on, it is possible to immediately perform the hot start. However, since the performance of the back positioning naturally involves power consumption, it is undesirable to perform the back positioning without limitation. For example, if the back positioning is repeatedly performed without limitation when a time period during which the power of the host device is off is relatively long, the remaining battery capacity of the electronic device is exhausted without the user knowing such a situation, with the result that it is impossible to start up the host device when the power of the host device is subsequently turned on. This situation naturally needs to be avoided. Hence, a technology for reducing power consumption by minimizing useless back positioning, back positioning of low necessity or the like is required. The same is true for the performance of the back positioning when the operation mode of the host device is a power-saving mode or the like.

### SUMMARY OF THE INVENTION

According to the present invention, there is provided a first electronic device which is an electronic device that includes a host device, including: a positioning processing portion that positions the host device based on a signal from a satellite; and a positioning control portion that performs a back positioning control operation of intermittently performing the positioning as back positioning in a specific tune period including an off-period in which power of the host device is off, where the positioning control portion compares a time difference between a time when a preceding round of positioning is successfully performed with respect to a starting time of the specific time period and the starting time of the specific time period with a predetermined first reference time, and prevents a start of the back positioning control operation when the time difference is equal to or more than the first reference time.

According to the present invention, there is provided a second electronic device which is an electronic device that includes a host device, including: a positioning processing portion that positions the host device based on a signal from a satellite; and a positioning control portion that performs a back positioning control operation of intermittently performing the positioning as back positioning in a specific time period including an off-period in which power of the host device is off, where the positioning control portion completes the performance of the back positioning control operation when the back positioning continuously fails for a predetermined first reference time or more or when all rounds of the positioning including one or a plurality of rounds of the positioning performed before the specific time period and one or a plurality of rounds of the back positioning performed in the specific time period continuously fail for the predetermined first reference time or more.

According to the present invention, there is provided a third electronic device which is an electronic device that includes a host device, including: a positioning processing portion that positions the host device based on a signal from a satellite; and a positioning control portion that performs a back positioning control operation of intermittently performing the positioning as back positioning in a specific time period including an off-period in which power of the host device is off, where the positioning control portion completes the performance of the back positioning control operation when the positioning control portion determines, based on a result of a plurality of rounds of the back positioning, that a position of the host device does not change for a predetermined second reference time or more.

According to the present invention, there is provided a fourth electronic device which is an electronic device that includes a host device, including: a positioning processing portion that positions the host device based on a signal from a satellite; and a positioning control portion that performs a back positioning control operation of intermittently performing the positioning as back positioning in a specific time period including an off-period in which power of the host device is off, where the positioning control portion completes the performance of the back positioning control operation when a time elapsed from a starting time of the specific time period is equal to or more than a predetermined third reference time.

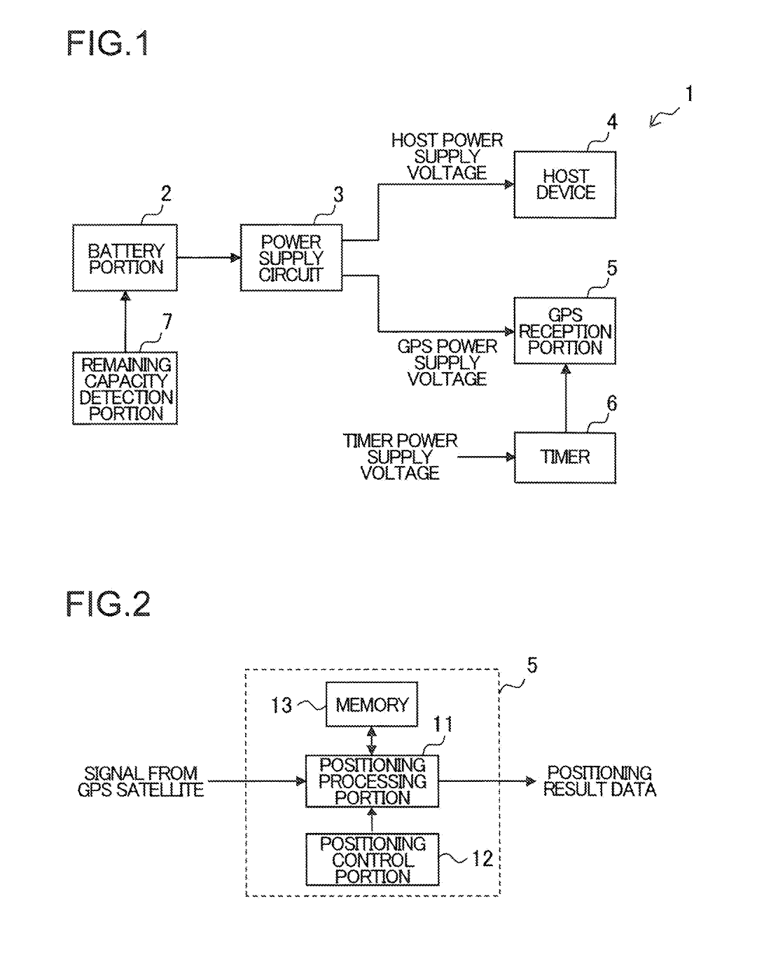

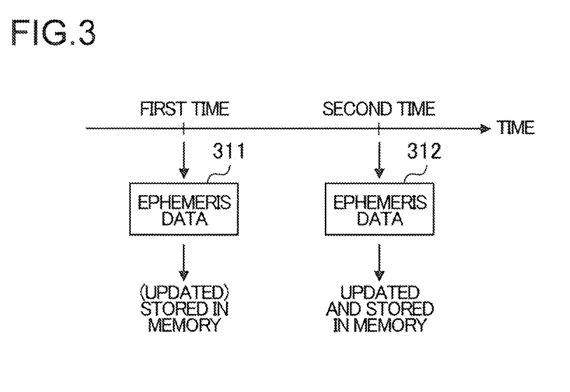

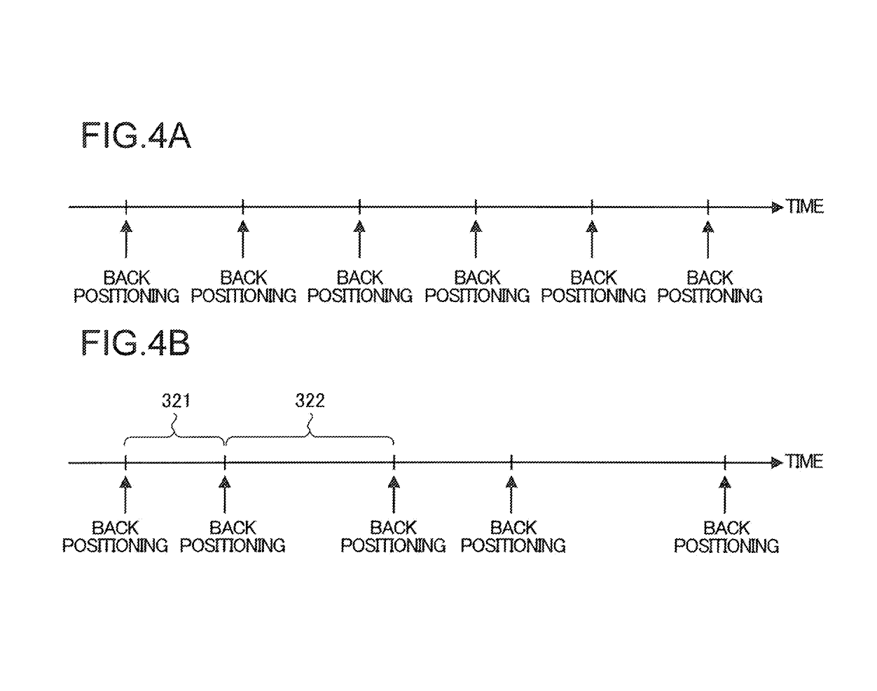

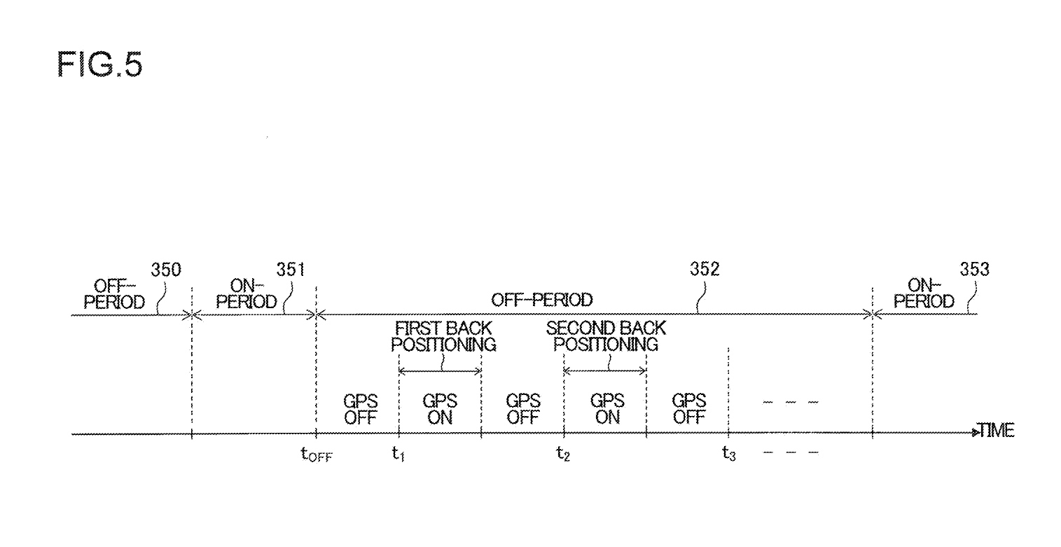

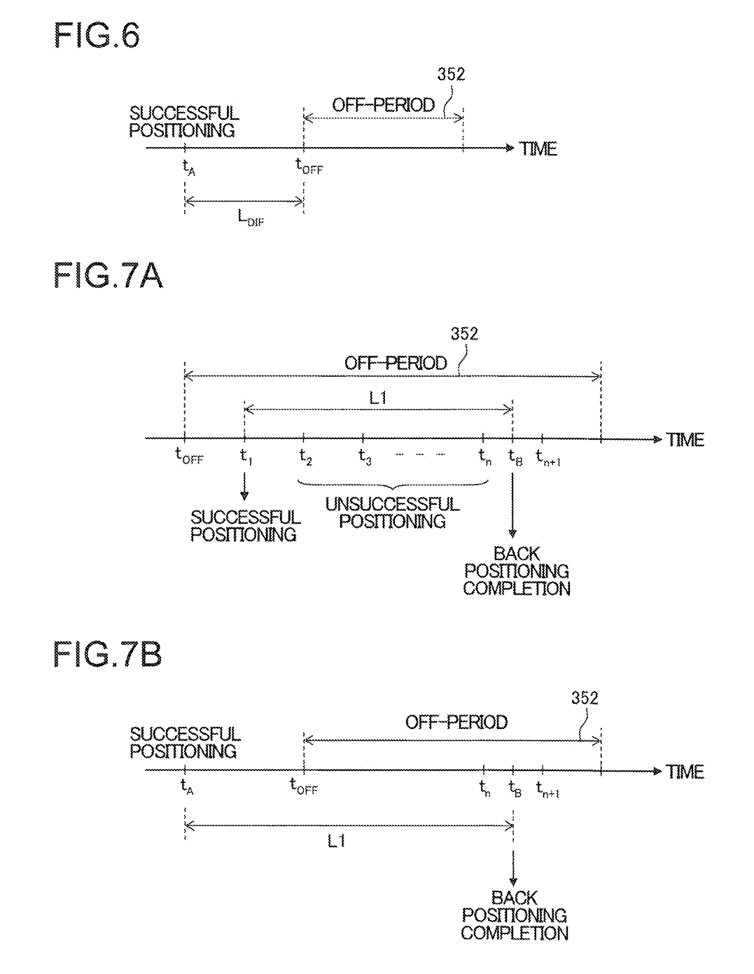

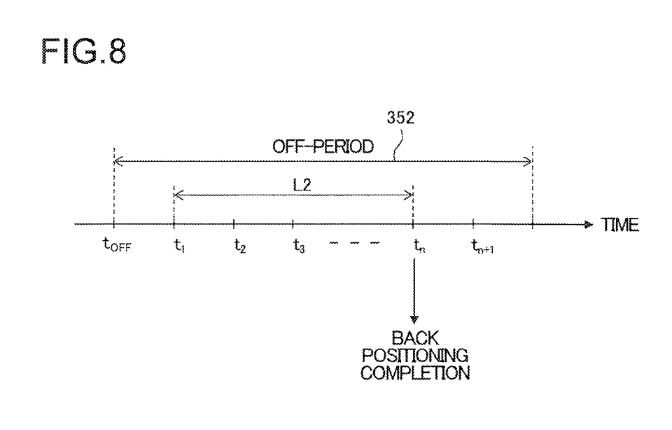

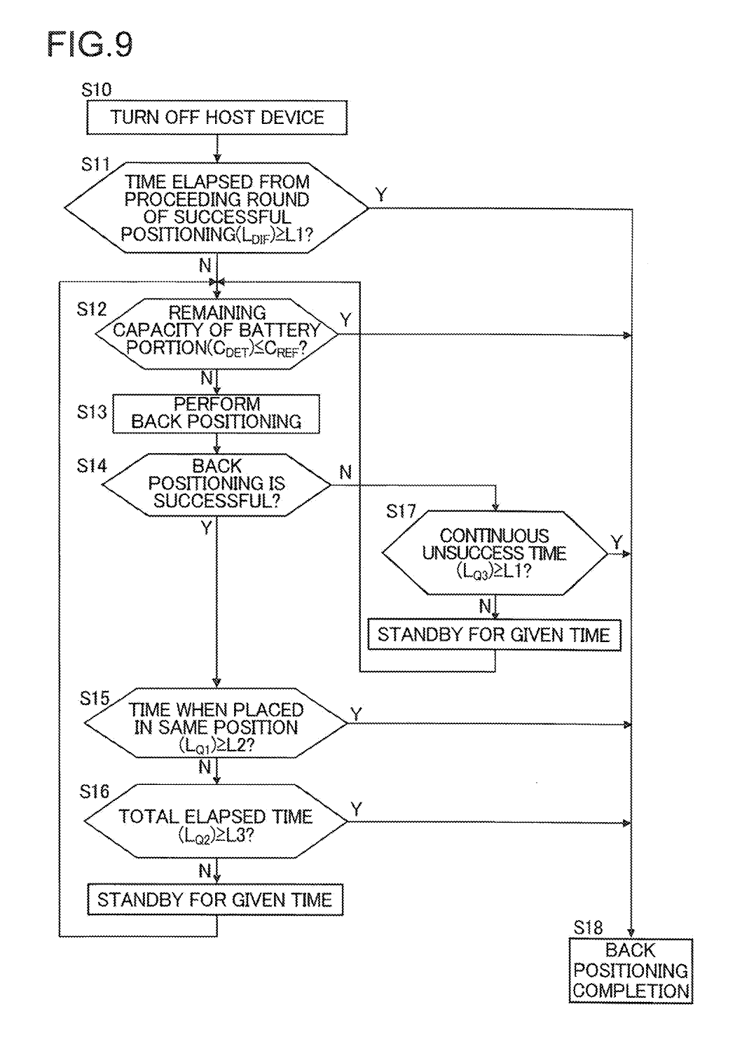

### BRIEF DESCRIPTION OF THE DRAWINGS

[FIG. 1] A schematic block diagram of an electronic device according to an embodiment of the present invention;

[FIG. 2] An internal block diagram of a GPS reception portion shown in FIG. 1;

[FIG. 3] A diagram for illustrating an operation of storing ephemeris data;

[FIGS. 4A-4B] Are diagrams showing timing at which a plurality of rounds of back positioning are performed;

[FIG. 5] A diagram showing a timing relationship between an on-period, an off-period, a time when the back positioning is performed and the like;

[FIG. 6] A diagram for illustrating a first limitation method according to the present embodiment of the present invention;

[FIGS. 7A-7B] Are diagrams for illustrating a second limitation method according to the present embodiment of the present invention;

[FIG. 8] A diagram for illustrating a third limitation method according to the present embodiment of the present invention; and

[FIG. 9] A flowchart of a back positioning control operation by the positioning control portion of FIG. 2.

### DESCRIPTION OF EMBODIMENTS

An example of the embodiment of the present invention will be specifically described below with reference to accompanying drawings. In the drawings referenced, like parts are identified with like symbols, and their description will not be repeated in principle.

FIG. 1 shows a schematic block diagram of an electronic device 1 according to the embodiment of the present invention. The electronic device 1 includes a battery portion 2, a power supply circuit 3, a host device 4, a GPS reception portion 5, which should also be called a GPS receiver, a timer 6 and a remaining capacity detection portion 7. In particular, a portable electronic device or an electronic device that is incorporated in a moving member such as a vehicle or a ship and that can be moved is assumed to be the electronic device 1.

The battery portion 2 is formed with one or a plurality of cells, and an output voltage of the cells of the battery portion 2 is fed as an output voltage of the battery portion 2 to the power supply circuit 3. The cell of the battery portion 2 may be a primary cell such as an alkaline cell or may be a secondary cell such as a nickel-metal hydride cell or a lithium-ion cell.

The power supply circuit 3 generates a host power supply voltage and a GPS power supply voltage from the output voltage of the battery portion 2. When the voltage value of the output voltage of the battery portion 2 is different from the voltages values of the host power supply voltage and the GPS power supply voltage, a power conversion circuit (not shown) is incorporated into the power supply circuit 3, and, with the power conversion circuit, it is possible to covert the output voltage of the battery portion 2 into the host power supply voltage and the GPS power supply voltage.

The host device 4 is an arbitrary information device that can perform the acquisition, the reproduction, the process or the like on arbitrary information; the information device is, for example, a digital camera, a game machine, a personal computer, a mobile telephone, an electronic book reader, an electronic dictionary or a navigation device. The electronic device 1 itself may be regarded as the information device described above. The digital camera, which is the information device, is a digital still camera that can shoot and record only a still image or a digital video camera that can shoot and record a still image and a moving image.

FIG. 2 shows an internal block diagram of the GPS reception portion 5. The GPS reception portion 5 includes a positioning processing portion 11, a positioning control portion 12 and a memory 13. The GPS reception portion 5 receives signals transmitted from three or more satellites (hereinafter referred to as GPS satellites) forming the global positioning system (hereinafter referred to as the GPS), and positions the host device 4 based on the reception signals. In the present embodiment, the reception signal indicates, unless otherwise specified, a signal obtained by receiving a signal transmitted from the GPS satellite.

The positioning of the host device 4 is performed under control of the positioning control portion 12 by the positioning processing portion 11. The positioning of the host device 4 refers to “processing that receives signals transmitted by three or more GPS satellites, that acquires, from the reception signals, ephemeris data on the three or more GPS satellites and that determines the position of the host device 4 based on the acquired ephemeris data.” The determined position of the host device 4 includes a latitude, a longitude and an altitude of the host device 4. The altitude of the host device 4 may not be included in the determined position of the host device 4. As is known, ephemeris data on a certain GPS satellite includes trajectory information on the GPS satellite and time information indicating an exact time The memory 13 stores the ephemeris data acquired by the positioning of the host device 4 while updating it.

The results of the positioning of the host device 4, that is, the latitude, the longitude and the altitude of the host device 4 which have been determined, are output as positioning result data to the host device 4. The host device 4 can perform arbitrary processing by utilizing the positioning result data. For example, when the host device 4 is a digital camera., shooting-site information based on the positioning result data can be stored in a recording medium (not shown) together with image data on a shot image. Alternatively, for example, when the host device 4 is a navigation device, it is possible to perform a necessary navigation operation with the positioning result data. Since the position of the host device 4 is the same as that of the electronic device 1, the positioning of the host device 4 is equivalent to that of the electronic device 1. In the following description, the positioning of the host device 4 or the electronic device 1 is also simply expressed as positioning. Processing for realizing positioning is referred to as positioning processing.

The timer 6 is formed with a clock generator, a counter (both of which are not shown) and the like, and measures a time elapsed from an arbitrary time.

The remaining capacity detection portion 7 detects the remaining capacity of the battery portion 2. When the battery portion 2 is formed with one cell, the remaining capacity of the cell corresponds to the remaining capacity of the battery portion 2. When the battery portion 2 is formed with a plurality of cells, the total of the remaining capacities of the cells corresponds to the remaining capacity of the battery portion 2. The remaining capacity of the battery portion 2 or the cell is an amount that is proportional to the amount of power which the battery portion 2 or the cell can output without the battery portion 2 or the cell being charged. As the method of detecting the remaining capacity of the battery portion 2, an arbitrary method including a known method can be utilized. For example, a voltage sensor and a current sensor (both of which are not shown) that detect the output voltage and the output current of the battery portion 2 are provided, and thus it is possible to detect the remaining capacity of the battery portion 2 from the detection values of the output voltage and the output current of the voltage sensor and the current sensor.

The host device 4 operates by using the host power supply voltage as a drive voltage. The host power supply voltage is fed from the power supply circuit 3 to the host device 4 only when the operation of the host device 4 is necessary. A time period during which the host power supply voltage is fed to the host device 4 is a time period (hereinafter also referred to as an on-period) during which the power of the host device 4 is on; a time period during which the host power supply voltage is not fed to the host device 4 is a timer period (hereinafter also referred to as an off-period) during which the power of the host device 4 is off. A user performs a predetermined operation the electronic device 1, and thereby can turn the power of the host device 4 from off to on or from on to off. When, in the on-period, predetermined conditions are satisfied (for example, no operation is performed on the electronic device 1 for a given period of time), the power of the host device 4 may be turned from on to off regardless of the operation of the user. For example, when the host device 4 is a digital camera, only in the on-period, the power from the battery portion 2 is fed through the power supply circuit 3 to the host device 4, and the host device 4 realizes the function (such as an operation of shooting a still image or a moving image) of the digital camera.

The GPS reception portion 5 operates by using the GPS power supply voltage as a drive voltage. The GPS power supply voltage can be fed to the GPS reception portion 5 in any one of the on-period and the off-period. The timer 6 operates by using the timer power supply voltage as a drive voltage. For example, an output voltage of a timer secondary cell (not shown) provided in the electronic device 1 is fed to the timer 6 as the timer power supply voltage. The timer power supply voltage may be fed from the battery portion 2. The GPS power supply voltage may be fed as the timer power supply voltage to the timer 6.

In the following description, the timer power supply voltage is assumed to be constantly fed to the timer 6. The GPS power supply voltage is fed to the GPS reception portion 5 only when the positioning processing is performed. However, the GPS power supply voltage may be constantly fed to the GPS reception portion 5. Even if the GPS power supply voltage is constantly fed to the GPS reception portion 5, the power consumption of the GPS reception portion 5 is very low while the positioning processing is not performed.

In the on-period, the GPS reception portion 5 performs the positioning periodically and repeatedly. The timer 6 may be used to determine timing at which the positioning is performed. For example, in the on-period, the positioning is periodically performed at intervals of a few tens of seconds or a few minutes. In the on-period, the positioning may be irregularly performed.

The GPS reception portion 5 does not always satisfactorily receive a signal from the GPS satellite, and cannot acquire ephemeris data from the reception signals depending on the reception environment. Positioning in which the ephemeris data of the GPS satellite necessary for calculating the position of the host device 4 can be acquired from the reception signals is referred to as successful positioning; a state where the ephemeris data of the GPS satellite necessary for calculating the position of the host device 4 can be acquired from the reception signals is expressed as the success of positioning. Positioning in which the ephemeris data of the GPS satellite necessary for calculating the position of the host device 4 cannot be acquired from the reception signals is referred to as unsuccessful positioning; a state where the ephemeris data of the GPS satellite necessary for calculating the position of the host device 4 cannot be acquired from the reception signals is expressed as the unsuccess of positioning.

The ephemeris data stored in the memory 13 is the ephemeris data of the GPS satellite necessary for calculating the position of the host device 4, and the ephemeris data stored in the memory 13 is sequentially updated and stored. Specifically, as shown in FIG. 3, when at the first time (first time point), the positioning is successfully performed to obtain ephemeris data 311, the ephemeris data 311 is stored in the memory 13, and in this case, when ephemeris data acquired before the first time is stored in the memory 13, the ephemeris data stored in the memory 13 is updated from the ephemeris data acquired before the first time to the ephemeris data 311. When at the second time after the first time, the positioning is successfully performed again o obtain ephemeris data 312, the ephemeris data stored in the memory 13 is updated from the ephemeris data 311 to the ephemeris data 312. Between the first time and the second time, one or more rounds of unsuccessful positioning may be present.

As is known, as the positioning processing, the cold start in which about 36 or more seconds are needed to complete the positioning and the hot start in which the positioning is completed in about 5 seconds are present. However, there is a time limit in the performance of the hot start. Specifically, it is possible to perform the hot start only within a specified time L0 (for example, about 2 hours) since the preceding round of acquisition of ephemeris data; after the specified time L0 has elapsed since the preceding round of acquisition of ephemeris data, only the cold start can be performed. The hot start is positioning processing that can be performed when effective ephemeris data is stored in the memory 13, and is performed using the effective ephemeris data stored in the memory 13. When the effective ephemeris data is not stored in the memory 13, the hot start cannot be performed, and the positioning is performed with the cold start. The specified time L0 is a time that corresponds to the length of the life of ephemeris data specified by the GPS. The ephemeris data whose life is completed is not effective.

In a case where the off-period is longer than the specified time L0, if no positioning is performed in the off-period, when the power of the host device 4 is subsequently turned on, only the cold start can be performed. In order to prevent such a situation, the GPS reception portion 5 intermittently performs the positioning even in the off-period. In the following description, in order for positioning performed in the on-period and positioning performed in the off-period to be distinguished, the positioning performed in the on-period is particularly called positive positioning, and the positioning performed in the off-period is particularly called back positioning. The positioning at the first time and the second time described with reference to FIG. 3 is either the positive positioning or the back positioning; any one of the positioning at the first time and the positioning at the second time may be the positive positioning, and the other may be the back positioning.

An operation of intermittently performing the back positioning in the off-period is called a back positioning control operation. In the off-period, the positioning control portion 12 uses the output of the timer 6 to perform the back positioning control operation. Here, the interval at which two rounds of back positioning adjacent in time are performed is assumed to be constant. In other words, in the off-period, as shown in FIG. 4A, the back positioning is periodically performed at regular intervals. The regular interval is, for example, a time period ranging from a few minutes to a few tens of minutes. However, as shown in FIG. 4B, the interval at which two rounds of back positioning adjacent in time are performed may not be constant. In other words, for example, the interval 312 at which the first round of back positioning and the second round of back positioning are performed may be different from the interval 322 at which the second round of back positioning and the third round of back positioning are performed.

FIG. 5 shows a timing relationship between the on-period, the off-period, a time when the back positioning is performed and the like that are assumed in the present embodiment. A time t_{OFF} is a time when the power of the host device 4 is tuned from on to off. An on-period from a predetermined time before the time t_{OFF} to the time t_{OFF} is called an on-period 351; an off-period from the time t_{OFF} to a predetermined time after the time t_{OFF} is called an off-period 352. Hence, the time t_{OFF} coincides with the completion time of the on-period 351 and the starting time of the off-period 352. An off-period immediately before the on-period 351 is called an off-period 350; an on-period immediately after the off-period 352 is called an on-period 353.

In the following description, the ith round of back positioning indicates the ith round of back positioning that is performed in the off-period 352 unless otherwise specified (the variable i is an integer). When at the time t_{OFF}, the power of the host device 4 is turned off the power of the GPS reception portion 5 is also turned off, and thereafter the power of the GPS reception portion 5 is turned on at a time t₁ in order to perform the first round of back positioning. When the positioning processing for the first round of back positioning is completed, the power of the GPS reception portion 5 is turned off, and thereafter the power of the GPS reception portion 5 is turned on again at a time t₂ in order to perform the second round of back positioning. Then, when the positioning processing for the second round of back positioning is completed, the power of the GPS reception portion 5 is turned off again. The repeated performance of the back positioning described above is performed in the off-period 352. When the power of the GPS reception portion 5 is on in the off-period 352, the GPS reception portion 5 receives the supply of the GPS power supply voltage to perform the back positioning. When the power of the GPS reception portion 5 is off in the off-period 352, the back positioning is naturally not performed. When at the time t_{OFF}, the power of the host device 4 is turned off and when the positioning processing for the ith round of back positioning is completed, the operation mode of the GPS reception portion 5 may be transferred to a low-power sleep mode instead of turning off the power of the GPS reception portion 5. As the power of the GPS reception portion 5 is off, even when the operation mode of the GPS reception portion 5 is the sleep mode, no back positioning is performed. Even when the power of the GPS reception portion 5 is off or even when the operation mode of the GPS reception portion 5 is the sleep mode, the ephemeris data is held in the memory 13 or the host device 4.

The time t₁ is a time after the time t_{OFF}; a time tᵢ₊₁ is a time after a time tᵢ. When the back positioning is periodically performed, regardless of the value of the variable i, the interval between the time t₁ and the time tᵢ₊₁ is constant (for example, a few minutes to a few tens of minutes). After the power of the host device 4 is turned off, the time t₁ may arrive without delay. Specifically, when at the time t_{OFF}, the power of the host device 4 is turned off, the first round of back positioning may be immediately performed. Then, for :example, each time a given period of time elapses with respect to the time t₁ i startup signal (trigger signal) is generated in the timer 6, and the startup signal is preferably fed to the GPS reception portion 5. Each time the GPS reception portion 5 receives the startup signal, one round of back positioning is performed. If the electronic device 1 is configured such that the GPS power supply voltage is fed to the GPS reception portion 5 only when the positioning processing is performed, the startup signal is also fed to the power supply circuit 3, and thus the supply of the GPS power supply voltage and the performance of the positioning processing are preferably synchronized with each other.

The back positioning is performed, and thus, even if the off-period 352 is longer than the specified time L0, when the power of the host device 4 is subsequently turned on it is possible to immediately perform the hot start However, since the performance of the back positioning naturally involves power consumption, it is not desirable to perform the back positioning without limitation. This is because: for example, if the back positioning is repeatedly performed without limitation when the off-period is relatively long, the remaining capacity of the battery portion 2 is exhausted without the user knowing it, and, when the power of the host device 4 is subsequently turned on, it is impossible to start the host device 4.

In view of the foregoing, the GPS reception portion 5 imposes a predetermined limitation on the start of or the performance of the back positioning control operation. First to fifth limitation methods for determining this limitation will be illustrated below. The GPS reception portion 5 uses one or more limitation methods among the first to fifth limitation methods, and thereby can impose the limitation on the start of or the performance of the back positioning control operation.

[First Limitation Method]

The first limitation method will be described. In general, the hot start requires a processing time of about 1 to 10 seconds whereas the cold start requires a processing time of about 36 to 90 seconds. Hence, when the back positioning is assumed to be the hot start, it is only necessary to wait for (10+10×k₁) seconds to determine whether the back positioning is successful or unsuccessful whereas, when the hack positioning is assumed to be the cold start, it is necessary to wait for (90+90×k₂) seconds to determine whether the back positioning is successful or unsuccessful (k₁ and k₂ are, for example, 0.1 to 1.0). In other words, when the back positioning is limited to only the hot start, it is possible to complete one round of back positioning for (10+10×k₁) seconds whereas, when the back positioning is allowed to be also the cold start, a processing time of (90+90×k₂) seconds is necessary for one round of back positioning. The increase in the processing time naturally causes power consumption to be increased.

As described above, since the power consumption of the cold start is significantly larger than that of the hot start, in the first limitation method and the second limitation method to be described later, in order for a period of the hot start to be extended (a period of the hot start with respect to the initial round of positioning in the on-period), the back positioning is limited to only the hot start (in other words, the back positioning of the cold start is prevented). When focus is placed on the off-period 352, the limitation of the back positioning to only the hot start means that, for example, if the success of positioning is not detected in (10+10×k₁) seconds after the start of the ith round of back positioning at the time tᵢ, the ith round of back positioning is determined to fail at that time, and the ith round of back positioning is completed.

Then, if the specified time L0 or more elapses from a time t_{A} when the latest successful positioning is performed before the off-period 352 is reached to the time t_{OFF}, the performance of the back positioning in the off-period 352 is useless (see FIG. 6). In this case, even if the back positioning is performed, it is impossible to obtain ephemeris data this is because the initial round of positive positioning in the on-period 353 is inevitably the cold start.

Hence, the positioning control portion 12 according to the first limitation method determines a time elapsed from the time t_{A} to the time t_{OFF}, that is, a time difference L_{DIF} between the time t_{A} and the time t_{OFF} (see FIG. 6), and the time difference L_{DIF} is compared with a predetermined reference time L1. Then, if the time difference L_{DIF} is equal to or more than the reference time L1, the positioning control portion 12 prevents (prohibits) the start of the back positioning control operation in the off-period 352. In other words, if the time difference L_{DIF} is equal to or more than the reference time L1, no back positioning is performed in the off-period 352. If the time difference L_{DIF} is less than the reference time L1, such prevention (prohibition) is not performed, and the back positioning is performed one or more times in the off-period 352.

The time t_{OFF} corresponds to the starting time of the off-period 352 (the time when the power of the host device 4 is turned from on to off); the time t_{A} corresponds to a time when the preceding round of positioning is successfully performed with respect to the starting time of the off-period 352. The successful positioning at the time t_{A} is successful positioning, among rounds of successful positioning performed before the time t_{OFF}, that is performed at a time closest to the time t_{OFF}. The time t_{A} can he a time belonging to the off-period 350 or the on-period 351 (see FIG. 5) or can be a time belonging to an off-period before the off-period 350 or a time belonging to an on-period before the on-period 351.

The reference time L1 is a time (time length) corresponding to the specified time L0 described above so that the hot start is achieved. Typically, for example, the reference time L1 is made equal to the specified time L0. A time shorter or longer than the specified time L0 only by a predetermined time ΔL may be set at the reference time L1. In the present embodiment, times or time differences using an alphabetical symbol “L” including L0, L1, L_{DIF} and ΔL described above and L2, L3, L_{Q1}, L_{Q2} and L_{Q3} to be described later are different from the times (time points) using an alphabetical symbol “t”, and they are terms that represent a time period (length of time).

In the first limitation method, useless back positioning that does not facilitate the realization of the hot start when the host device 4 is subsequently started is prevented from being performed. It is also possible to reduce a large amount of power consumption caused by the performance of the back positioning of the cold start. In other words, in the electronic device 1 that can realize the increase in the speed of the positioning (hot start) when the host device 4 is subsequently started, the first limitation method is applied, and thus it is possible to reduce useless or excessive power consumption in the off-period.

[Second Limitation Method]

The second limitation method will be described with reference to FIGS. 7A and 7B. Under the assumption that the back positioning in the off-period 352 is limited to only the hot start, when the back positioning continuously fails for the specified time L0 or more, the initial round of positive positioning in the on-period 353 is inevitably the cold start, and thus it is useless to perform the back positioning any more.

Hence, the positioning control portion 12 according to the second limitation method completes the performance of the back positioning control operation at the time when, after the start of the performance of the back positioning control operation in the off-period 352, the back positioning continuously fails for the reference time L1 or more (see FIG. 7A). When the performance of the back positioning control operation is completed in the off-period 352, no back positioning is newly performed in the off-period 352 after such completion.

For example, as shown in FIG. 7A, consider a case where the first round of back positioning performed at the time t₁ is the successful positioning, the second to nth rounds of back positioning performed at the times t₂ to tₙ are all unsuccessful positioning and a tune t_{B} at which only the reference time (time period) L1 elapses from the time t₁ is a time between the time tₙ and a time tₙ₊₁. In this case, after the nth round of back positioning is performed at the time tₙ, the back positioning control operation is completed without the (n+1)th round of back positioning being performed at time tₙ₊₁. The completion of the back positioning control operation has the same meaning as the completion of the performance of the back positioning control operation. The variable n is an integer; in the example of FIG. 7A, the variable n is an integer of 3 or more. The time t_{B} can be the time tₙ or the time tₙ₊₁. In the example of FIG. 7A, if the nth round of back positioning is the successful positioning, the back positioning control operation is continued after the time tₙ, and, if the back positioning continuously fails for the reference time L1 or more after the time tₙ, the back positioning control operation is completed at that time.

Alternatively, if all rounds positioning including one or a plurality of rounds of positioning performed before the off-period 352 and one or a plurality of rounds of back positioning performed in the off-period 352 continuously fail for the reference time L1 or more, the performance of the back positioning control operation is completed at that time. In other words, for example, as shown in FIG. 7B, consider a case where the positioning (the positive positioning or the back positioning) performed at the time t_{A} described above is the successful positioning, one or more rounds of positioning (the positive positioning or the back positioning) performed after the time t_{A} but before the time tₙ and the nth round of back positioning in the off-period 352 performed at the time tₙ are all unsuccessful positioning and the tune t_{B} at which only the reference time L1 elapses from the time t_{A} is a time between the time tₙ and the time tₙ₊₁. In this case, after the nth round of back positioning is performed at the time tₙ, the back positioning control operation is completed without the (n+1)th round of back positioning being performed at the time tₙ₊₁. As described above, the time t_{B} can be the time tₙ or the time tₙ₊₁. In the example of FIG. 7B, the variable n is an integer of 1 or more.

As in the first limitation method, in the second limitation method, useless back positioning that does not facilitate the realization of the hot start when the host device 4 is subsequently started is prevented from being performed. It is also possible to reduce a large amount of power consumption caused by the performance of the back positioning of the cold start. Thus, it is possible to reduce useless or excessive power consumption in the off-period.

[Third Limitation Method]

The third limitation method will be described with reference to FIG. 8. A state where the host device 4 is arranged in the same place for a long period of time is estimated to correspond to a state where the host device 4 is left without being used for a long period of time. The need to continue the back positioning in such a state is low.

Hence, the positioning control portion 12 according to the third limitation method determines, after the start of the performance of the back positioning control operation, based on the positioning result data on a plurality of rounds of back positioning performed in the off-period 352, whether or not the position of the host device 4 (in other words, the position of the electronic, device 1) is changed in the off-period 352. Then, based on the determination result, if the positioning control portion 12 determines that the position of the host device 4 is not changed for a predetermined reference time L2 or more in the off-period 352, the positioning control portion 12 completes the performance of the back positioning control operation at the time when such a determination is made. Determining that the position of the host device 4 is not changed for the reference time L2 or more in the off-period 352 is called position still determination for convenience. It is preferable to set a time longer than the specified time L0 and the reference time L1 at the reference time L2.

For example, as shown in FIG. 8, consider a case where a time at which only the reference time L2 elapses from the time t₁ is the time tₙ or a time between the time tₙ₋₁ and the time tₙ, and the n rounds of back positioning performed at the times t₁ to tₙ include a plurality of rounds of successful positioning. In this case, the positioning control portion 12 determines, based on a plurality of pieces of positioning result data obtained by the plurality of rounds of successful positioning, whether or not the position of the host device 4 is changed within a period from the time t₁ to the time tₙ. If the position of the host device 4 indicated by the positioning result data is the same between the plurality of pieces of positioning result data, the position still determination is made whereas if not, the position still determination is not made. Then, when the position still determination is made at the time tₙ, the back positioning control operation is completed without the (n+1)th round of back positioning being performed at the time tₙ₊₁. In the example of FIG. 8, the variable n is an integer of 2 or more.

In the third limitation method, in the state where the need to continue the back positioning is estimated to be low, the back positioning is prevented from being newly performed. Thus, it is possible to reduce power consumption caused by the performance of the back positioning of low necessity.

Fourth Limitation Method]

The fourth limitation method will be described. A state where the power of the host device 4 is kept off for a long period of time is estimated to correspond to a state where the host device 4 is left without being used for a long period of time. The need to continue the back positioning in such a state is low.

Hence, the positioning control portion 12 according to the fourth limitation method uses, after the start of the performance of the back positioning control operation, a timer 6 to monitor a time elapsed from the starting time (that is, the time t_{OFF}) of the off-period 352, and, when the elapsed time reaches a predetermined reference time L3 or more, the performance of the hack positioning control operation is completed. In other words, after the elapsed time reaches the reference time L3 or more, the back positioning is prevented from being newly performed in the off-period 352. It is preferable to set a time longer than the specified time L0 and the reference time L1 at the reference time L3.

As in the third limitation method, in the fourth limitation method, in the state where the need to continue the hack positioning is estimated to he low, the back positioning is prevented from being newly performed. Thus, it is possible to reduce power consumption caused by the performance of the back positioning of low necessity.

[Fifth Limitation Method]

The fifth limitation method will be described. It is not desirable that the remaining capacity of the battery portion 2 is excessively reduced by the performance of the back positioning.

Hence, the positioning control portion 12 according to the fifth limitation method monitors, in the off-period 352, the remaining capacity C_{DET} of the battery portion 2, and, when the remaining capacity C_{DET} reaches a predetermined reference capacity C_{REF} or less, the back positioning is prevented from being newly performed. In order to realize what has been described above, the remaining capacity detection portion 7 is preferably made to periodically detect the remaining capacity of the battery portion 2, even in the off-period 352. The remaining capacity C_{DET} indicates the value of the detection of the remaining capacity of the battery portion 2 by the remaining capacity detection portion 7.

If it is detected, before the time t₁ the off-period 352, that the remaining capacity C_{DET} of the battery portion 2 is equal to or less than the reference capacity C_{REF}, the positioning control portion 12 can prevent (prohibit) the start of the back positioning control operation in the oft-period 352 (in other words, the positioning control portion 12 can complete the back positioning control operation in the off-period 352 without performing the back positioning). If it is detected, after the start of the back positioning control operation in the off-period 352 (in other words, after the back positioning is performed in the off-period 352 one or more times), that the remaining capacity C_{DET} of the battery portion 2 is equal to or less than the reference capacity C_{REF}, the positioning control portion 12 can complete the performance of the back positioning control operation in the off-period 352 at the time of the detection (in other words, after it is detected that the remaining capacity of the battery portion 2 is equal to or less than the reference capacity C_{REF}, the positioning control portion 12 can prevent the back positioning from being newly performed).

In the fifth limitation method, by performance of the hack positioning, it is possible to prevent the remaining capacity of the battery portion 2 from being excessively reduced.

[Operational Flowchart]

FIG. 9 is a flowchart showing the procedure of the back positioning control operation. The procedure of the back positioning control operation will be described with reference to FIG. 9. Although in the back positioning control operation of FIG. 9, all the first to fifth limitation methods described above are realized, only four or less of the first to fifth limitation methods may be realized. The first, second, third, fourth and fifth limitation methods are realized by the types of processing in steps S11, S17, S15, S16 and S12, respectively.

When in step S10, the power of the host device 4 is turned from on to off, and the off-period 352 is started, the positioning control portion 12 first makes a determination in step S11. In step S11, a time elapsed from the time of the preceding round of successful positioning (that is, the time t_{A} of FIG. 6) to the time t_{OFF}, that is, the time difference L_{DIF} of FIG. 6 is determined, and the time difference L_{DIF} is compared with the reference time L1. Then, if a first inequality “L_{DIF}≧L1” holds true, the process moves from step S11 to step S18, and thereafter the back positioning is prevented from being newly performed in the off-period 352. On the other hand, if the first inequality does not hold true, the process moves from step S11 to step S12.

In step S12, the positioning control portion 12 compares the remaining capacity C_{DET} of the battery portion 2 at the current time with the reference capacity C. Then, if a second inequality “C_{DET}≦C_{REF}” holds true, the process moves from step S12 to step S18, and thereafter the back positioning is prevented from being newly performed in the off-period 352. On the other hand, if the second inequality does not hold true, the process moves from step S11 to step S13.

In step S13, the positioning control portion 12 makes the positioning processing portion 11 perform the back positioning only one time. In the subsequent step S14, the positioning control portion 12 determines whether or not the back positioning in step S13 is successful. If the back positioning in step S13 is successful, the process moves from step S14 to step S15 whereas, if the back positioning in step S13 is unsuccessful, the process moves horn step S14 to step S17. If the back positioning is successful, as described above, the ephemeris data stored in the memory 13 is updated to the latest ephemeris data by the latest round of back positioning.

In step S15, the positioning control portion 12 determines, based on positioning result data on a plurality of rounds of back positioning including the latest round of back positioning, a time L_{Q1} during which the host device 4 is continuously arranged in the same place in the off-period 352, and the time L_{Q1} is compared with the reference time L2. Then, if a third inequality “L_{Q1}≧L2” holds true, the process moves from step S15 to step S18, and thereafter the back positioning is prevented from being newly performed in the off-period 352. On the other hand, if the third inequality does not hold true, the process moves from step S15 to step S16. For example, when the first to fifth rounds of back positioning performed at the times t₁ to t₅ are all the successful positioning, and the positioning result data of the first to fifth rounds are obtained by the first to fifth rounds of back positioning, if the position of the host device 4 indicated by the positioning result data is the same among the positioning result data of the first to fifth rounds, the time L_{Q1} at the time when the positioning result data of the fifth round is obtained is a time difference between the time t₁ and the time t₅ whereas, if the position of the host device 4 indicated by the positioning result data is different between the positioning result data of the first round and the positioning result data of the second round but is the same among the positioning result data of the second to fifth rounds the time L_{Q1} at the time when the positioning result data of the fifth round is obtained is a time difference between the time t₂ and the time t₅.

In step S16, the positioning control portion 12 compares a total elapsed time L_{Q2} that is a time elapsed from the starting time of the off-period 352 with the reference time L3, and, if a fourth inequality L_{Q2}≧L3” holds true, the process moves from step S16 to step S18, and thereafter the back positioning is prevented from being newly performed in the off-period 352. On the other hand, if the fourth inequality does not hold true, the process is placed on standby for only a given period of time corresponding to the interval at which the back positioning is performed, and then returns to step S12. The cancellation of the standby state is realized using the startup signal of the timer 6.

In step S17, the positioning control portion 12 compares a continuously unsuccessful time L_{Q3} with the reference time L1, and, if a fifth inequality “L_{Q3}≧L1” holds true, the process moves from step S17 to step S18, and thereafter the back positioning is prevented from being newly performed in the off-period 352. On the other hand, if the fifth inequality does not hold true, the process is placed on standby for only the given period of time corresponding to the interval at which the back positioning is performed, and then returns to step S12. The cancellation of the standby state is realized using the startup signal of the timer 6. The continuously unsuccessful time L_{Q3} corresponds to the total time of continuous unsuccessful positioning; a time difference between the current time and the time when the latest successful positioning is performed can be used as the continuously unsuccessful time L_{Q3}.

The inequality sign “≧” in the first, third, fourth or fifth inequalities described above can be changed to an inequality sign “>”; the inequality sign “≦” in the second inequality described above can be changed to an inequality sign “<”.

By controlling the performance of the back positioning as described above, it is possible to realize the increase in the speed of the positioning (hot start) when the host device 4 is subsequently started while reducing useless consumption of the battery capacity or the like. In other words, it is possible to realize the increase in the speed of the positioning when the host device 4 is subsequently started while maintaining balance with the battery life.

[Operational Variation α]

An operational variation α that corresponds to a variation of the operation described above will now be described. The state where the power of the host device 4 is on, which is assumed in the above description, corresponds to a state where the operation mode of the host device 4 is a normal mode. The state which the host device 4 can be in is able to include not only the state where the operation mode of the host device 4 is the normal mode but also a state where the operation mode of the host device 4 is the power-saving mode. For example, when no operation from the user is performed on the electronic device 1 for a given period of time or more or when a predetermined operation is performed on the electronic device 1, the operation mode of the host device 4 is transferred from the normal mode to the power-saving mode. For example, when the operation mode of the host device 4 is the power-saving mode, if any operation is performed on the electronic device 1, the operation mode of the host device 4 is transferred from the power-saving mode to the normal mode. As compared with when the operation mode of the host device 4 is the normal mode, when the operation mode of the host device 4 is the power-saving mode, the power consumption of the host device 4 is low but the function that can be realized in the host device 4 is limited or the speed of various types of processing in the host device 4 is reduced.

A time period during which the operation mode of the host device 4 is the normal mode is called a normal time period; a time period during which the operation mode of the host device 4 is the power-saving mode is called a power-saving time period. In the operational variation α, the various types of methods on the back positioning described above are applied when the operation mode of the host device 4 is the power-saving mode. In other words, in the operational variation α, the on-period and the off-period described above are replaced with the normal time period and the power-saving time period, and thus various types of operations described above are performed. Hence, for example, in the operational variation α, the positive positioning and the back positioning indicate the rounds of positioning performed in the normal time period and the power-saving time period, respectively, the back positioning control operation indicates an operation of intermittently performing the back positioning in the power-saving time period, the time t_{OFF} indicates a time when the operation mode of the host device 4 is turned from the normal mode to the power-saving mode and the off-period 350, the on-period 351, the off-period 352 and the on-period 353 in FIG. 5 are replaced with the power-saving time period 350, the normal time period 351, the power-saving time period 352 and the normal time period 353, respectively.

Each of the off-period and the power-saving time period is one type of specific time period in which the back positioning control operation needs to be performed.

Various modifications are possible in the embodiment of the present invention as necessary within the scope of technical ideas indicated in the scope of claims. The embodiment described above is simply illustrative of the embodiment of the present invention; the significance of the present invention and the terms of configuration requirements is not limited to what has been described in the above embodiment. The specific values indicated in the above description are simply illustrative; they can be naturally changed into various values. As explanatory notes that can be applied to the above embodiment, explanatory notes 1 and 2 are described below. The details described in the explanatory notes can be arbitrary combined unless otherwise a contradiction arises.

[Explanatory Note 1]

In the description of the first limitation method, the limitation of the back positioning to only the hot start has been discussed. However, it is not always necessary to apply this limitation to all rounds of back positioning according to the present invention, and the back positioning according to the present invention can be the cold start. In particular, in the realization of the third to fifth limitation methods, the back positioning may be the cold start. The cold start is included in the target of the back positioning, and thus the possibility that the hot start s realized is increased when the host device 4 is subsequently started.

Explanatory Note 2]

The electronic device 1 can be formed with hardware or a combination of hardware and software. When the electronic device 1 is formed with software, a block diagram of portions that are realized by software indicates a functional block diagram of those portions. By writing, as a program, a function achieved with software and performing the program on program execution device (for example, computer), the function may be achieved.

What is claimed is:

1. An electronic device that includes a host device, comprising:
a positioning processing portion that positions the host device based on a signal from a satellite; and
a positioning control portion that performs a back positioning control operation of intermittently performing the positioning as back positioning in a specific time period including an off-period in which power of the host device is off,
wherein the positioning control portion compares a time difference between a time when a preceding round of positioning is successfully performed with respect to a starting time of the specific time period and the starting time of the specific time period with a predetermined first reference time, and prevents a start of the back positioning control operation when the time difference is equal to or more than the first reference time.

2. The electronic device of claim 1,
wherein the host device is driven based on an output voltage of a battery portion formed with one or a plurality of cells, and
the positioning control portion also prevents the start of the back positioning control operation when a remaining capacity of the battery portion at the starting time of the specific time period is equal to or less than a predetermined reference capacity.

3. The electronic device of claim 1,
wherein the host device is driven based on an output voltage of a battery portion formed with one or a plurality of cells, and
the positioning control portion completes the performance of the back positioning control operation when a remaining capacity of the battery portion is equal to or less than a predetermined reference capacity after the start of the back positioning control operation.

4. An electronic device that includes a host device, comprising:
a positioning processing portion that positions the host device based on a signal from a satellite; and
a positioning control portion that performs a back positioning control operation of intermittently performing the positioning as back positioning in a specific time period including an off-period in which power of the host device is off,
wherein the positioning control portion completes the performance of the back positioning control operation
when the back positioning continuously fails for a predetermined first reference time or more or
when all rounds of the positioning including one or a plurality of rounds of the positioning performed before the specific time period and one or a plurality of rounds of the back positioning performed in the specific time period continuously fail for the predetermined first reference time or more.

5. An electronic device that includes a host device, comprising:
a positioning processing portion that positions the host device based on a signal from a satellite; and
a positioning control portion that performs a back positioning control operation of intermittently performing the positioning as back positioning in a specific time period including an off-period in which power of the host device is off,
wherein the positioning control portion completes the performance of the back positioning control operation when the positioning control portion determines, based on a result of a plurality of rounds of the back positioning, that a position of the host device does not change for a predetermined second reference time or more.

6. An electronic device that includes a host device, comprising:
a positioning processing portion that positions the host device based on a signal from a satellite; and
a positioning control portion that performs a back positioning control operation of intermittently performing the positioning as back positioning in a specific time period including an off-period in which power of the host device is off,
wherein the positioning control portion completes the performance of the back positioning control operation when a time elapsed from a starting time of the specific time period is equal to or more than a predetermined third reference time.

7. The electronic device of claim 4,
wherein the host device is driven based on an output voltage of a battery portion formed with one or a plurality of cells, and
the positioning control portion also completes the performance of the back positioning control operation when a remaining capacity of the battery portion is equal to or less than a predetermined reference capacity.

8. The electronic device of claim 5,
wherein the host device is driven based on an output voltage of a battery portion formed with one or a plurality of cells, and
the positioning control portion also completes the performance of the back positioning control operation when a remaining capacity of the battery portion is equal to or less than a predetermined reference capacity.

9. The electronic device of claim 6,
wherein the host device is driven based on an output voltage of a battery portion formed with one or a plurality of cells, and
the positioning control portion also completes the performance of the back positioning control operation when a remaining capacity of the battery portion is equal to or less than a predetermined reference capacity.

10. The electronic device of any one of claim 1,
wherein the specific time period is equal to the off-period.

11. The electronic device of any one of claim 4,
wherein the specific time period is equal to the off-period.

12. The electronic device of any one of claim 5,
wherein the specific time period is equal to the off-period.

13. The electronic device of any one of claim 6,
wherein the specific time period is equal to the off-period.
